(19) United States
(12) Patent Application Publication
(10) Pub. No.: US 2005/0236049 A1
(43) Pub. Date: Oct. 27, 2005

(54) In-line multi-port selector valve

(76) Inventors: Ronald James Manson, Spring, TX (US); Russell Eric McBeth, The Woodlands, TX (US)

Correspondence Address: FISH & RICHARDSON P.C., 1717 MAIN STREET, SUITE 5000, DALLAS, TX, 75201, US

(21) Appl. No.: 10/833,901

(22) Filed: Apr. 27, 2004

(51) Int. Cl. F16K 11/072

(52) U.S. Cl. 137/625.11

(57) ABSTRACT

A multi-port selector valve has a valve body that includes an inlet port module, and outlet port module, and a port selector. The port selector is rotatably disposed in the valve body and includes a flow path disposed through the port selector, a path inlet, a path outlet, and an offset portion. The path inlet has a first flow direction and the path outlet has a second flow direction. The offset portion includes a longitudinal flow direction with an angle of less than 90 degrees with the first flow direction.

### TECHNICAL FIELD

This invention relates to valves, and more particularly to multi-port valves.

### BACKGROUND

Valves have a variety of applications in numerous industries. In the production of oil and natural gas, valves are a necessity in any operation due to the need for directing the flow of fluids (gas, water, and oil) between wells, pumps, vessels, and refineries. In general, oil and gas development includes well drilling, production (bringing fluids to the surface), treating the various mixtures of oil and gas, and the transportation to oil refineries and gas sales points. Many production fields consist of numerous wells producing fluids comprising natural gas, oil and water individually, simultaneously, or collectively. Generally, the fluids from the wells are transported to a central collection or gathering station to combine or further separate them for subsequent aspects of development, such as refining, gas sales, etc. Accordingly, the production of each well is generally directed to a manifold system that communicates the well products to various testing and/or production destinations upon production. Additionally, the numerous destinations for materials require the use of a myriad of valves and pipe systems to direct flow to a desired location.

Using multi-port valves is well known. However, most multi-port valves are designed to have multiple inlets and a single outlet. Additionally, most multi-port systems direct the flow from an opening through a chamber with selectively opened and closed outlets for fluid. The use of these multi-port valves allows multiple inputs to be directed to a single destination. Though appropriate for some applications, the multi-outlet valves operate only to direct fluid to a single destination, absent additional piping and valve systems.

In addition to gathering production fluids from wells, often different types of fluids or other matter is required to be sent down into the well. For example, treating solutions to dissolve terrestrial rock formations and scale compounds must be directed down-hole to facilitate production. Additionally, pipe scrapers, commonly known as pipeline “pigs” may be required to be propelled through the piping systems to the wells by pressurized fluid flow to remove scale and debris that can limit production rates. Each pipeline pig requires a launcher and a receiver. The piping configuration necessary to support pigging operations is normally extensive, due to the pressure required to propel the pig from the launcher through the piping to the receiver portion of the system.

### SUMMARY

A multi-port selector valve allows for a single opening to communicate with multiple outlets. In oil and gas production and testing operations, the requirement to change the direction of fluid flow from a source is often present. Additionally, without a multi-port selector valve, large networks of piping must be implemented that allow for a branched flow wherein each branch is required to have its own valve to stop or start the flow from the branch to the destination.

A multi-port selector valve reduces the space and complexity of piping networks in various applications. In one implementation, a multi-port selector valve includes a valve body having an inlet port module and an outlet port module. A port selector that includes a flow path is rotatably disposed in the valve body. The flow path includes a path inlet, a path outlet, and an offset portion disposed between the path inlet and path outlet. The path inlet has a flow direction substantially parallel to an outlet flow direction, and the offset portion has an angle less than 90 degrees to the path inlet's flow direction.

A method for directing flow includes providing a valve body with an inlet port module and an outlet port module, a port selector with a flow path disposed there through, and a rotation power source for rotating the port selector. The flow path includes a path inlet with a first direction of flow, a path outlet with a second direction of flow, and an offset portion disposed between the path inlet and path outlet, within the offset portion has longitudinal flow direction with an angle of less than 90° to the second flow direction.

Implementations of the valve provide various advantages. For example, valves manufactured or provided in accordance with implementations of the invention may reduce the necessary space for piping applications. This is particularly advantageous on offshore production platforms or sensitive environmental areas where space is a premium. Additionally, certain implementations allow for more efficient flow transfer from one output location to another.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG 1A is a cutaway plan view of a 4-way valve in accordance with an embodiment of the present invention.

FIG. 1B is an end view of the valve of FIG. 1A.

FIG. 2 is a plan view of a valve having a reversed direction of flow.

FIG. 3A is a cutaway plan view of a 4-way valve that includes flanged outlets.

FIG. 3B is an end view of the valve of FIG. 3A.

FIG. 4A is a cutaway plan view of a 3-way valve with welded outlets.

FIG. 4B is an end view of the valve of FIG. 4A.

FIG. 5A is a cutaway plan view of a 3-way valve with a manual lever-type actuator.

FIG. 5B is a cross-sectional view of the valve of FIG. 5A along the line A-A′.

FIG. 6A is a plan view of a manifold system that incorporates one or more valves in accordance with embodiments of the present invention.

FIG. 6B is a side view of the manifold system depicted in FIG. 6A.

Like reference symbols in the various drawings indicate like elements.

### DETAILED DESCRIPTION

Described in more detail below is a multi-port selector valve having one inlet and multiple outlets or one outlet and multiple inlets. Though numerous embodiments and implementations are shown, it should be understood that many additional embodiments and implementations may be used in accordance with the teachings of the present invention. For the purposes of this application, the term “fluid” includes oil, gas, water, or any other matter either individually or in any combination. Other matter may include, but is not limited to entrained solids, suspended solids, and slurries of solids.

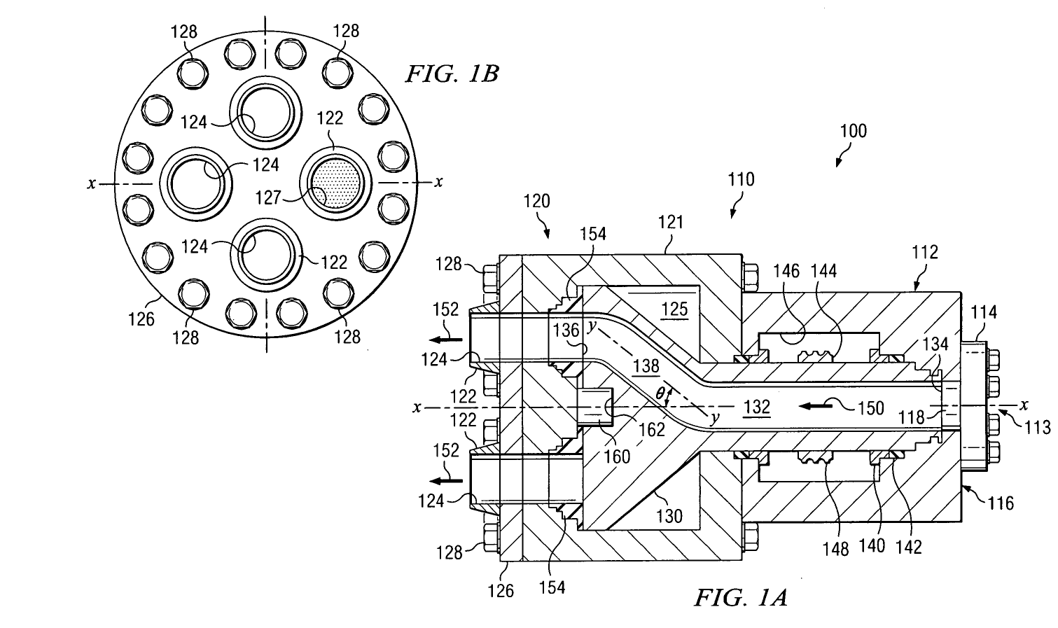

Referring to FIGS. 1A and 1B, a valve system 100 includes a body 110. In the embodiment shown, the body 110 includes an inlet port module 112, an outlet port module 120, and a port selector 130. The inlet port module 112 has an inlet port body 116 adapted to connect to a fluid source through an inlet port flange 114. The inlet port body 116 may be adapted to partially enclose the port selector 130. In the embodiment shown, the inlet port body 116 includes an open yoke 146. The port selector 130 is coupled to the inlet port body 116 via bushings 140. Seals 142 may also be included to prevent fluid entering or exiting the inlet port module 112 from leaking out of the valve body 116.

The inlet port flange 114 has an opening 113 that allows fluid to enter the valve body 110. The inlet port body 114 may also include a bearing 118 for rotatably coupling the path inlet body 114 to the port selector 130.

The outlet port module 120 includes an outlet port body 121 and a plurality of welded outlet ports 122 formed in an outlet plate 126. The four welded outlet ports 122 are shown as welded outlet ports 122, but any suitable type of outlet port may be used. Welded outlet ports 122 define outlets 124. The welded outlet ports 122 may be adapted to be coupled to fluid destinations (not explicitly shown), and each outlet port 122 may be spaced radially outward from the central axis of the port selector, herein labeled the “X-X” axis. Outlet plate 126 is attached to the outlet port module 120 using fasteners 128. The fasteners 128 may be any suitable type of fastener, such as a screw, bolt, nut and bolt assembly, or other suitable fastener.

The port selector 130 may be a rotatable member that includes a flow path 132 formed within, such that the flow path 132 may allow the transfer of fluid from the opening 113 to one of the plurality of outlets 124. The port selector 130 is disposed within the valve body 110 such that it passes through portions of the inlet port module 112 and the outlet port module 120. The flow path 132 formed within the port selector 130 has a path inlet 134, a path outlet 136, and an offset portion 138. Offset portion 138 includes a longitudinal flow direction Y-Y that preferably defines an angle θ of less than 90 degrees from the central longitudinal axis X-X, so that the flow path 130 may be operable to provide communication between the opening 113 and one of the plurality of outlets 124. The offset portion 138 is angled so that as the port selector 130 is rotated within the valve body 110, the path outlet 136 may be aligned with one of the plurality of outlets 124. Additionally, a blinded outlet 127 may be formed in the endplate 126 such that when the path outlet 136 is aligned with the blinded outlet 127, no fluid may exit the valve system 100.

An advantage of the offset portion 138 having an angle θ less than 90 degrees is that certain operations, such as launching or receiving a pipe scraper through the valve system 100, are possible. A pipe scraper, or pipeline “pig” as they are commonly referred to in the petroleum industry, is routinely propelled through the pipes from a pipeline launcher in production operations by using pressurized fluid as a propellant. Additionally or alternatively, the pipeline scraper could be coupled to a pipeline scraper receiver. In accordance with the present invention, the smaller the angle θ, the less the amount of resistance a pipe scraper, or pipeline “pig” encounters when passing through the valve. Accordingly, an angle θ of greater than 90 degrees may be prohibitive in certain applications. The pipeline scraper may be propelled from the launcher or toward the receiver using a pressurized fluid source.

Other advantages of having a longitudinal flow path with an 0 angle of less than 90° to the first flow path include minimizing scale and paraffin deposition in the flow path due to minimizing pressure drop in the offset position 138; minimizing erosion of the internal walls of the flow path in the offset portion 138; and reducing the likelihood of cavitation in the offset portion 138.

In the embodiment shown, an actuator coupling 144 is disposed circumferentially about the port selector 130. In the configuration illustrated by FIG. 1A, the open yoke 146 allows rotational energy to be transmitted from a rotation power source (not shown) via a chain, belt, gear, or other suitable connector to engage the teeth 148 of the actuator coupling 144. As the port selector 130 is rotated within the valve body 110, the path outlet 136 may be aligned with one of the plurality of outlets 124 defined by the welded outlet ports 122 formed in the end plate 126. This alignment allows fluid to pass through open outlets 124 or be stopped by a blinded outlet 127.

In the embodiment shown, the port selector 130 is operable to align the flow path 132 with one of four outlets 124, although in other embodiments, there may be more or less than four outlets 124 formed within the outlet port module 120. Additionally, outlet seals 154 may be coupled to welded outlet ports 122 to ensure a positive connection with the flow path 132 when the flow path 132 is aligned with the outlet port 122. The path inlet 134 has a first direction of flow 150 that is substantially parallel with the central longitudinal “X-X” axis. The path outlet 136 has a second direction of flow 152 that is substantially parallel to the first direction of flow 150 but offset from the central X-X axis.

The multi-port selector valve 100 also includes a trunnion 160 adapted to rotatably couple the port selector 130 to the outlet port module body 121. The trunnion pin 160 may be either adapted to insert into corresponding pin recess 162 formed in a portion of the outlet port module body 121 and a port selector recess 164 formed in the port selector 130. Alternatively, the trunnion pin may be formed integrally with either the port selector 130 and adapted to be inserted in the pin recess 162 or as part of the outlet port module body 121 and inserted into the port selector recess 164. Additionally, the outlet seals 154 may be adapted to provide pressure against the port selector 130, in order to maintain the relative position of the port selector 130 within the valve body 110, and/or to maintain the alignment between the flow path 132 and one of the plurality of outlets 124. The outlet seals 154 may be installed with one or more than one of the outlet ports 122. In one implementation, an outlet seal 154 may provide sealing properties that provide a seal to the outlet port(s) 122 with which it installed and/or provide a seal preventing pressure within the valve body 110 from entering into outlet port(s) 122.

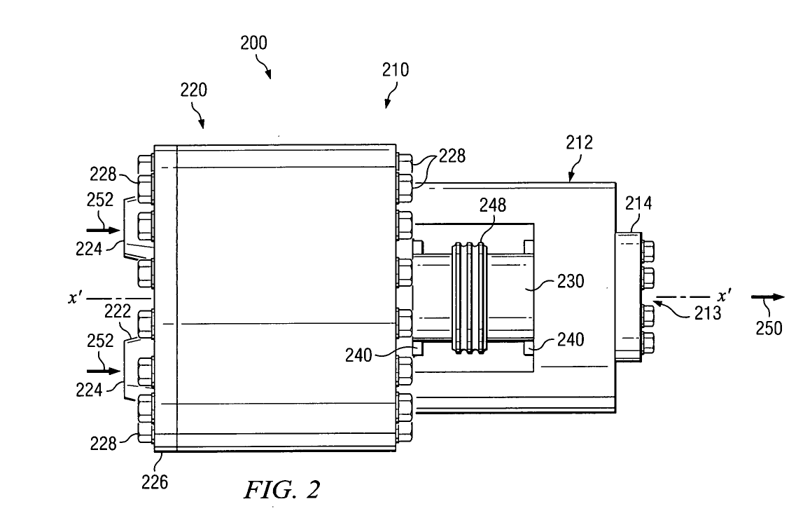

FIG. 2 illustrates an enclosed valve system 200 having a central longitudinal “X′-X′” axis and having substantially corresponding features of the valve illustrated by FIGS. 1A and 1B. Valve system 200 includes an embodiment in which the outlet port module and inlet port modules are reversed from the configuration illustrated by FIGS. 1A and 1B. For example, in FIG. 2, the outlet port module 120 is replaced by inlet port module 220, which includes a plurality of inlet ports 222 adapted to be coupled to a fluid source, and openings 224 formed in end plate 226. Each of the openings 224 may be adapted to correspond with a first direction of flow 252 substantially parallel to the central longitudinal X′-X′ axis of the valve body 210.

Fasteners 228 may be used to couple the end plate 226 to the inlet port module 220, as well as the inlet port module 220 to the outlet port module 212. Additionally, the embodiment shown includes an outlet flange 214 with an outlet 213 formed there through. The outlet flange 214 may be adapted to couple the valve system 200 to an associated fluid destination (not explicitly shown). The outlet 213 corresponds to a second direction of flow 250, which is substantially parallel to the first direction of flow 252. Also not shown is the flow path formed within the port selector 230 that is adapted to communicate between one of the plurality of openings 224 and the outlet 213 when the flow path, similar to the one depicted at reference number 132 of FIG 1A, is rotatably aligned with one of the plurality of openings 224.

Additionally, in the embodiment shown, but not necessary to the operation of the invention, the second direction of flow is shown to be centered substantially about the central longitudinal X′-X′ axis of the valve body.

As stated above, most features of the valve system 200 are analogous to those of valve system 100 as depicted in FIGS. 1A and 1B. As such, the valve system 200 also includes an actuator coupling 240 that includes teeth 248 that, when coupled to an actuator, is operable to rotate the port selector 230 so that the flow path not shown, may be aligned with one of the plurality of openings 224.

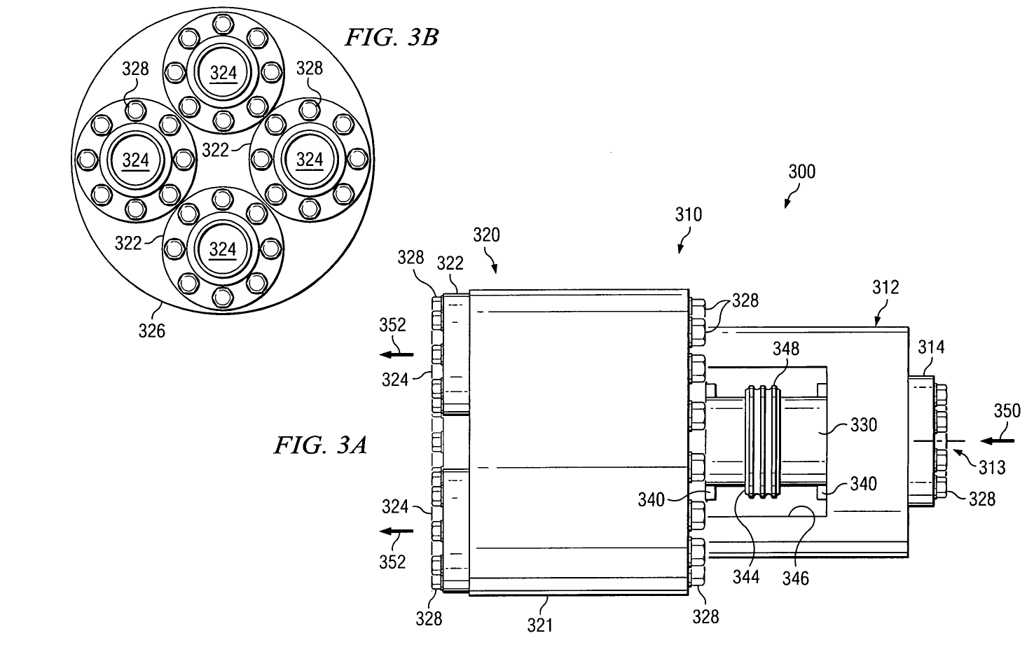

FIGS. 3A and 3B illustrate an alternate embodiment of a valve system 300. The major difference as illustrated by FIGS. 3A and 3B is that the valve system 300 does not include an end plate. Rather, the valve system 300 includes flanged outlet ports 322. Each of these flanged outlet ports 322 may be coupled to the outlet port module body 321 by using fasteners 328, such as bolts, rivets, or other suitable fasteners. Similar to the valve system 100 of FIGS. 1A and 1B, the valve system 300 includes outlets 324 adapted to direct fluid passing through the valve system 300 to a fluid destination. The fluid or other matter enters the valve system 300 through an opening 313 defined by an inlet flange 314 coupled to the inlet port module body 316 of the inlet port module 312. The valve body 310 may be assembled by using fasteners 328 to couple the outlet port module body 321 of the outlet port module 320 to the inlet port module body 316 of the inlet port module 312. Additionally, the port selector 330 may have actuator coupling 344 having teeth or gears 348 disposed within an open yoke 346 disposed within the inlet port module body 312. Upon transmission of rotational energy via a gear, chain, belt or other suitable connection to the actuator coupling 344, the port selector 330 will rotate a flow path formed within the port selector 330 similar to that shown at number 132 of FIG 1A, to align the path outlet (also not shown) with one of the plurality of outlets 324.

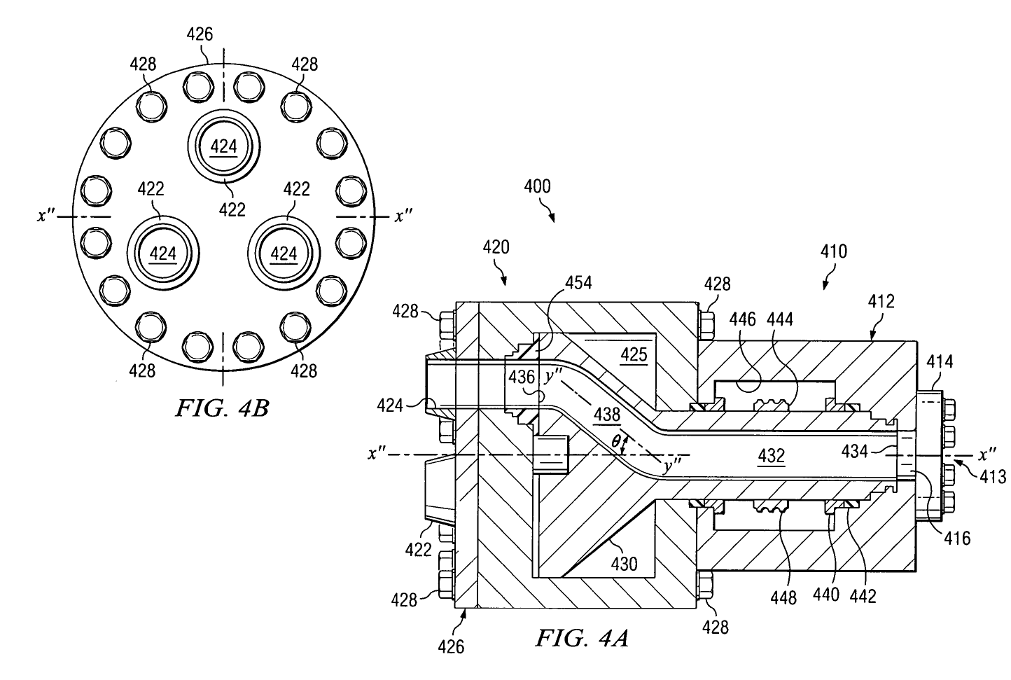

FIGS. 4A and 4B illustrate an alternative multi-port valve system 400 that includes three outlets 424 defined by the welded outlet ports 422 formed in the end plate 426 of the outlet port module 420. Additionally, no trunnion pin is present in the embodiment shown in FIG. 4A. According to this embodiment, the pressure of the fluid moving through the flow path 432 provides the necessary pressure along an axis X″-X″ to maintain pressure of the port selector 430 against the valve seat 454 when the flow path 432 is aligned with one of the three outlets 424. Similar to the embodiment shown in FIG 1A, the flow path 432 includes a path inlet 434 and a bearing 416 to rotatably couple the port selector 430, including the flow path 432 with the inlet flange 414 and the opening 413, respectively. The flow path 432 also has an offset portion 438 that includes a longitudinal flow direction Y″-Y″ that preferably defines an angle θ of less than 90 degrees from the central longitudinal axis X″-X″ so that the flow path is able to provide communication between the opening 413 and one of the plurality of outlets 424.

In one implementation illustrated in FIG. 4A, an actuator may be located within a closed yoke 446 to provide rotation of the actuator coupling 444. Seals 442 and bushings 440 may also be provided to ensure that the port selector 430 is maintained in proper physical relation to the valve body 410, and/or that no pressurized fluid enters the closed yoke 446 of the inlet port module 410.

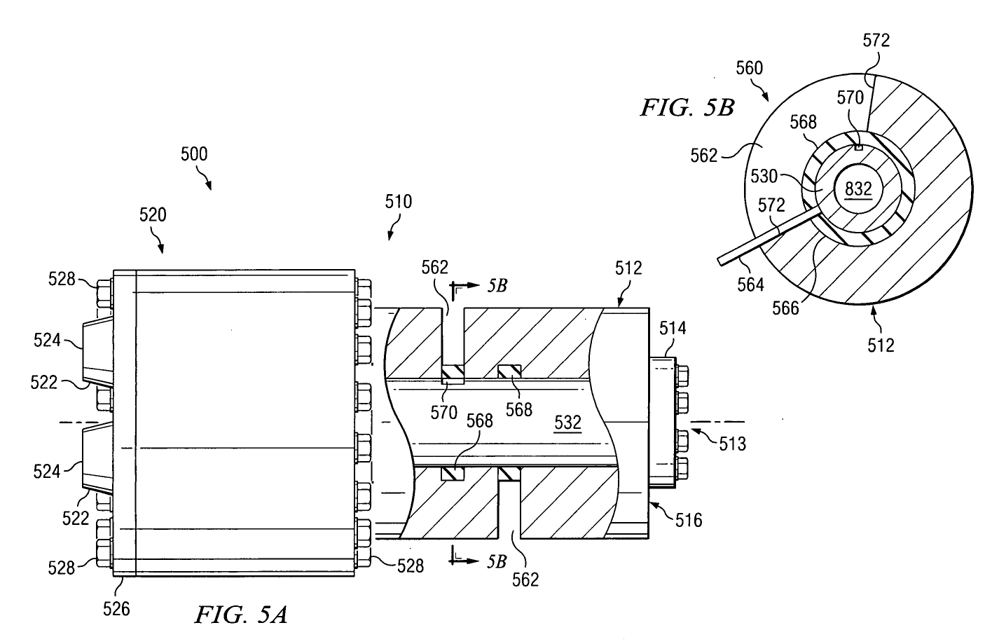

FIGS. 5A and 5B illustrate an in-line valve system 500 that allows manual manipulation of the port selector 530 by a lever system 560. The lever system 560 is best described in conjunction the cross section shown by FIG. 5B. The cross section A-A′ of FIG. 5B illustrates one or more port recesses 562 formed in the valve body 510 of the valve system 500. An actuator ring 568 may be disposed circumferentially about the port selector 530 that includes a lever recess 566 adapted to receive a lever 564. Upon inserting the lever 564 into the recess 566, a user can rotate the port selector 530 within the valve body 510 to align the flow path 532, which is formed in the port selector 530 in a similar fashion as the flow path 132 of FIG. 1A, to align the path outlet (not explicitly shown) with one of the plurality of outlets 524 defined by the welded outlet ports 522 of the outlet port module 520.

A key 570 may also be included. As depicted, the key 570 may couple the port selector 530 to the actuating ring 568. When the port selector 530 is rotated so that the flow path is aligned with one of the plurality of outlets 522, one of two port recess surfaces 572 in any port recess 562 engages the lever 564 to stop the rotation of the port selector 530 and therefore the flow path 532. The lever system 560 allows a user to manually rotate the flow path 532 of the port selector 530 so that the flow path 532 communicates between the opening 513 defined by the inlet flange 514 of the inlet port module 512 and the outlet 524 defined by the outlet port 522 formed in the end plate 526.

Multiple port recesses 562 may be formed in a given valve body 510. Where multiple port recesses 562 are present, the lever 564 may be removed from a first lever recess 566 in the actuator ring 568 and inserted into a second or subsequent lever recess 566 in the actuator ring 568 to allow further manual rotation of the port selector 530.

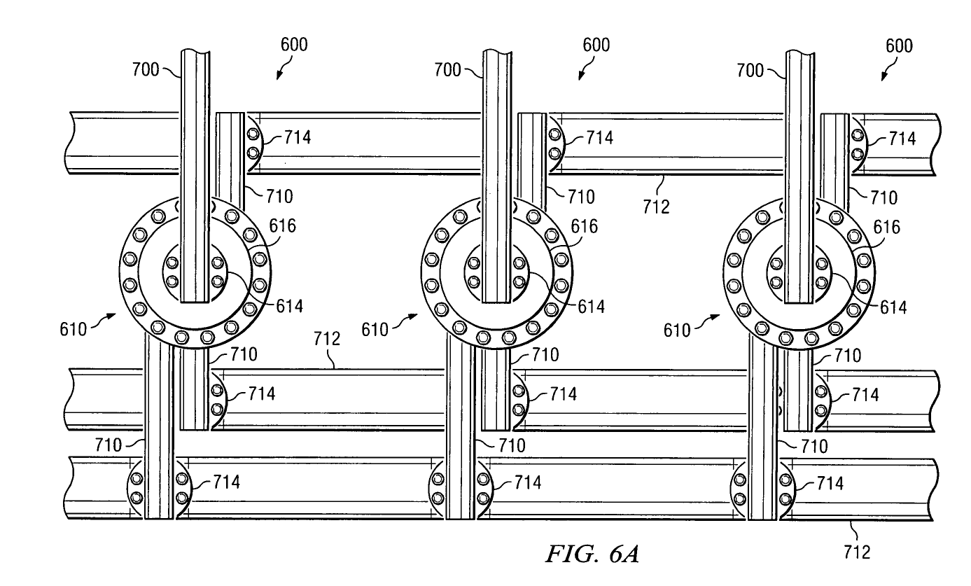

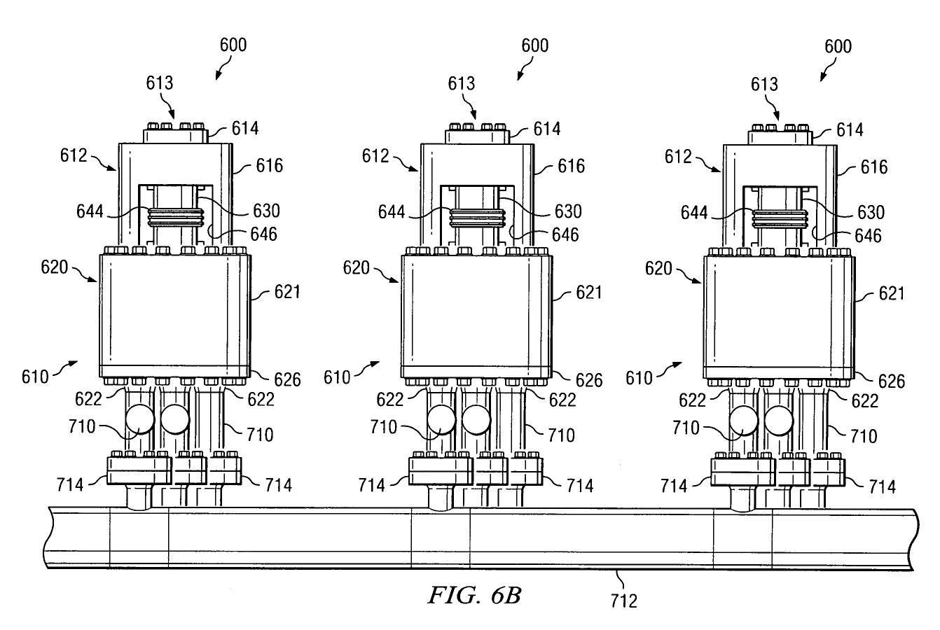

FIGS. 6A and 6B illustrate a manifold system 600 that incorporates a valve similar to that shown in the valve system 100 of FIG. 1A. The system 600 includes a valve body 610 with an inlet port module 612 and an outlet port module 620. Outlet ports 622 are adapted to be coupled to outlet pipes 710. In the embodiment shown, outlet pipes 710 are coupled to destination flanges on destination pipes 712 to transport fluid or other matter transported through the valve body 610. Opening 613 is formed in inlet flange 614 and is adapted to be coupled to inlet pipe 700 to allow fluid to enter the valve body 610 through the opening 613.

The port selector 630 is disposed within the valve body 610 to allow the selective manipulation of the fluid passing through the manifold system 600. For example, an actuator coupling 644 disposed about the port selector 630 may be acted upon by an external actuating means, such as a gear, belt, chain, or other suitable actuating means, so that the port selector 630 and a flow path formed there through (not explicitly shown) may be aligned with one of the plurality of outlet ports 622 to allow the communication of fluid or other matter from the opening 613 via the inlet pipe 700 through the manifold system 600 to a destination pipe 712.

A number of embodiments of the invention have been described. Nevertheless, it will be understood that various modifications may be made without departing from the spirit and scope of the invention. For example, in any of the disclosed embodiments, the first and second directions of flow may be reversed, so that the outlet flow is reversed to be an inlet flow, and vice versa. Additionally, any of the valve configurations may incorporate welded ports, flanged ports, or any other suitable coupling device for production applications. Though only 3-way and 4-way valve systems were disclosed, it should be understood that any number of outlet ports or inlet ports may be incorporated without departing from the spirit and scope of the present invention. For example, there may be multiple outlet ports and multiple inlet ports, with the flow path including an outlet offset portion and an inlet offset portion so that multiple sources and destinations may use the same valve system. Accordingly, other embodiments are within the scope of the following claims.

1. A multi-port selector valve comprising:
A valve body including:
an inlet port module having a body adapted to connect to a fluid source;
an outlet port module having a body with at least two outlet ports, each of said outlet ports adapted to connect to an outlet fluid destination; and
a port selector rotatably disposed in the valve body, said port selector being a rotatable member having a flow path there through, said flow path having
a path inlet;
a path outlet, said path outlet has a second flow direction substantially parallel to said first flow direction; and
an offset portion disposed there between, said offset portion has a longitudinal flow direction with an angle of less than 90 degrees to the first flow direction.

2. The valve of claim 1, wherein the path inlet of the rotatable member is disposed in the inlet port module and the outlet path of the rotatable member is disposed in the outlet port module.

3. The valve of claim 1, wherein the valve body further includes an inlet opening that is substantially aligned with the path inlet of the rotatable member.

4. The valve of claim 1, wherein each of the at least two outlet ports is adapted to be aligned with the path outlet of the rotatable member and one of a plurality of outlet fluid destinations.

5. The valve of claim 4, further comprising an outlet seal disposed within the valve body, the outlet seal adapted to provide a seal between one of the plurality of outlet ports and the valve body.

6. The valve of claim 5, wherein the outlet seal is further adapted to a seal preventing pressure within the valve body from entering into an outlet port.

7. The valve of claim 4, wherein one of the plurality of outlet ports defines a blind outlet, said blind outlet adapted to prevent the flow of fluid through the flow path when the flow path is aligned with the blind outlet.

8. The valve of claim 1, wherein the flow path is adapted to allow passage through the flow path of the valve of a pipeline scraper propelled by a pressurized fluid.

9. The valve of claim 1, wherein the port selector is rotatably coupled to the valve body by a trunnion.

10. The valve of claim 1, further comprising an actuator for rotating the rotatable member within the valve body.

11. The valve of claim 10, wherein the actuator includes an actuator coupling connected to the port selector and a drive mechanism adapted to rotatably engage the actuator coupling.

12. The valve of claim 10, wherein the actuator is enclosed within the valve body.

13. The valve of claim 10, wherein the actuator is external to the valve body, and wherein the valve body includes a recess to allow the actuator to engage the actuator coupling.

14. The valve of claim 1, further comprising an outlet port seat corresponding to each of the plurality of outlet ports, wherein the outlet port seats are adapted to maintain the alignment of the flow path with the outlet port when matter is passing through the flow path.

15. The valve of claim 4, wherein the plurality of outlet ports are welded outlet ports, the welded outlet ports formed in an end plate of the outlet port module and adapted to be coupled to one of the plurality of fluid destinations.

16. The valve of claim 4, wherein the plurality of outlet ports are flanged outlet ports, each of the flanged outlet ports adapted to be coupled to one of the plurality of fluid destinations.

17. A multi-port selector valve comprising:
a valve body including:
an inlet port module having a body with at least two inlet ports, each of said inlet ports adapted to connect to a fluid source, the inlet port defining a plurality of openings;
an outlet port module having a body adapted to connect to an outlet fluid destination; and
a port selector rotatably disposed in the valve body, said port selector having a flow path there through, said flow path including:
a path inlet;
a path outlet; and
an offset portion disposed there between, wherein the inlet path has a first flow direction, the outlet portion has a second flow direction substantially parallel to the first flow direction, and said offset portion has a longitudinal flow direction with an angle of less than 90 degrees to the second flow direction.

18. The valve of claim 17, further comprising an inlet port seal adapted to provide a seal pressure between the fluid source and the valve body.

19. The valve of claim 18, wherein the inlet port seal is further adapted to provide a seal pressure between the valve body and one of the at least two inlet ports.

20. The valve of claim 17, wherein the path inlet of the port selector is disposed in the inlet port module and the outlet path of the rotatable member is disposed in the outlet port module.

21. The valve of claim 20, wherein each of the at least two inlet ports is adapted to be coupled to a different fluid source.

22. The valve of claim 17, wherein the outlet port is a flanged outlet port adapted to be coupled to a fluid destination.

23. The valve of claim 20, wherein each of the plurality of inlet ports is a welded inlet port adapted to be coupled to one of a plurality of fluid sources.

24. The valve of claim 17, further comprising an actuator, wherein the actuator is operable to rotate the port selector within the valve body.

25. The valve of claim 24, wherein the actuator is external to the valve body.

26. The valve of claim 24, wherein the actuator is enclosed within the valve body.

27. A method for operating a multi-port selector valve, comprising:
providing a multi-port selector valve having a rotatable port selector disposed in a valve body, wherein a flow path formed in the port selector includes:
a first direction of flow corresponding to a path inlet;
a second direction of flow corresponding to a path outlet; and
an offset portion disposed there between, said offset portion having a longitudinal flow direction with an angle of less than 90 degrees with the first direction of flow;
coupling an inlet port module of the multi-port valve to at least one fluid source, wherein the inlet port module includes at least one inlet port coupled to a fluid source;
coupling an outlet port module of the valve body to at least one fluid destination, wherein the outlet port module includes at least two outlet ports; and
actuating the port selector disposed between the inlet port module and the outlet 14 port module so that a flow path formed in the port selector communicates fluid between the inlet port module and the outlet port module.

28. The method of claim 27, further comprising:
providing an outlet port seal coupled to at least one outlet ports, wherein the outlet port seal is adapted to provide a seal between the outlet port and the valve body.

29. The method of claim 27, further comprising providing an outlet port seal coupled with at least one of the outlet ports, wherein the outlet port seal is adapted to provide a seal preventing pressure within the valve body from entering into the outlet port.

30. The method of claim 27, further including propelling a pipeline scraper through the multi-port selector valve using a pressurized fluid from the fluid source.

31. The method of claim 27, wherein the step of actuating the port selector includes:
coupling an actuator to the port selector to rotate the port selector within the valve body; and
selectively rotating the port selector to rotate the flow path into alignment with one of the at least one outlet ports.
